(19) United States
(12) Patent Application Publication
(10) Pub. No.: US 2004/0099718 A1
(43) Pub. Date: May 27, 2004

(54) Card and pocket assembly

(76) Inventor: Jennifer Nichi Kleinhans, St. Louis Park, MN (US)

Correspondence Address: Jennifer N. Kleinhans, 8216 West 30 1/2 Street #105, St. Louis Park, MN, 55426, US

(21) Appl. No.: 10/303,082

(22) Filed: Nov. 21, 2002

(51) Int. Cl. B42D 15/00

(52) U.S. Cl. 229/92.8

(57) ABSTRACT

A greeting card which comprises a main panel having a front surface and a rear surface, the front surface having a message containment area. The greeting card further comprises a sleeve member overlapping at least a portion of the rear surface of the main panel. The sleeve member includes a bottom edge, a top edge and two side edges. Each of the two side edges and the bottom edge are engaged to the rear surface of the main panel. The sleeve member and the rear surface define a sleeve having an opening defined by the top edge of the sleeve member and the rear surface adjacent thereto. The sleeve constructed and arranged to receive and removably retain at least a portion of at least one stationary item.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

Envelopes, greeting cards, notes, invitations and other stationary products, hereinafter referred to collectively as paper products, may be designed with features designed to capture attention as well as to convey a message.

In some paper product applications it is desirable to not only provide a card, letter or other document which bears a message, but to also provide a ready available means for the recipient of the card, letter or document to respond to the message contained thereon. For example, in many business applications, an envelope containing a request for information, a solicitation, or a bill, may also contain a return postcard or a second envelope with which the recipient may send a response to the original sender. In another example, some wedding invitations may comprise a relatively large envelope, which contains the invitation itself; an RSVP, including an envelope; and in many cases other miscellaneous documents, including maps, registries, personal notes, etc.;.

Clearly such combinations of paper products may be complex. In some cases, depending on how the individual paper products are arranged, one or more of individual products, including the messages that they may be attempting to convey, may be misunderstood, lost, or simply ignored.

Where a large number of mailings rely on a combination of paper products as have been described above, an unprofessional, inefficient, or merely sloppy arrangement of cards, documents and return envelopes, in an invitation or other mailing may result in a poor rate of response, and may further result in a significant waste of time, money and resources, by the sender and/or the recipient.

In light of the above there remains a need in the paper products art, to provide an assembly of paper products, that may be suitable for mailing, is convenient to use, easy to arrange and includes features which attract attention to help ensure that a recipient does not ignore the assembly or its individual components.

In at least one embodiment, the present invention addresses this need by providing an assembly which comprises at least one card panel that is equipped with at least one panel member for containing a response envelope, card or other paper product item.

While there exists greeting cards that have been combined with sleeves, pouches, pockets or other devices for containing objects, such prior greeting card/device combinations do not address the need for providing an assembly of paper products, that may be suitable for mailing, is convenient to use, easy to arrange and includes features which attract attention to help ensure that a recipient does not ignore the assembly or its individual components as embodiments of the present invention do.

Some examples of these greeting card/container combinations are described in U.S. Pat. No. 6,003,254, which describes a combined greeting card and record sleeve; U.S. Pat. No. 5,133,496, which describes a combined greeting card and gift pouch; U.S. Pat. No. 5,575,384, which describes a combined greeting card and item carrier; and U.S. Pat. No. 6,148,550, which describes a money pocket that can be placed on the inside surface of a greeting card.

The entire content of all of the patents listed within the present patent application are incorporated herein by reference.

Without limiting the scope of the invention a brief summary of the claimed embodiments of the invention is set forth below. Additional details of the summarized embodiments of the invention and/or additional embodiments of the invention may be found n the Detailed Description of the Invention below.

A brief abstract of the technical disclosure in the specification is provided as ell only for the purposes of complying with 37 C.F.R. 1.72. The abstract is not intended to be used for interpreting the scope of the claims.

### BRIEF SUMMARY OF THE INVENTION

Without limiting the scope of the invention in any way, the invention is briefly summarized in some of its aspects below.

The present invention may be embodied in a variety of forms. In at least one embodiment the invention is directed to a trisectioned member, herein after referred to as a card in which the folds are above and below the main body of the card. The main body of the card includes a front surface and a back surface. The back surface further comprises a retaining member engaged to the back surface, the back surface and the retaining member define a retaining slot or sleeve in which other paper products, such as return envelopes, thank you notes, business reply letters, RSVP's or others may be placed.

In at least one embodiment the invention is directed to an assembly comprising the trisectioned card and the associated paper products for placement in the retaining sleeve.

In at least one embodiment, the invention is further directed to an envelope opened from the narrow end, and which is constructed and arranged to contain the trisectioned card and any paper products contained within the sleeve.

Additional details and/or embodiments of the invention are discussed below.

### BRIEF DESCRIPTION OF THE SEVERAL VIEWS OF THE DRAWINGS

A detailed description of the invention is hereafter described with specific reference being made to the following drawings.

FIG. 1 is a perspective view of an embodiment of the invention.

FIG. 2a is a frontal view of an embodiment of the invention in an open position.

FIG. 2b is a frontal view of an embodiment of the invention in a closed position.

FIGS. 3-5 show a rear view of an embodiment of an inventive card and further illustrate one manner in which a return envelope or other item may be inserted into a sleeve defined by the inventive card.

FIG. 6 is side view of the embodiment shown in FIG. 5 wherein the return envelope or other item is shown in an inserted position with in the sleeve of the inventive card.

FIG. 7 is frontal view of an embodiment of the return envelope or other item suitable for insertion into the sleeve of the inventive card shown in FIGS. 1 and 3-6.

FIG. 8 is a frontal view of an embodiment of the invention which includes the inventive card of FIG. 1 and a unique sending envelope.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

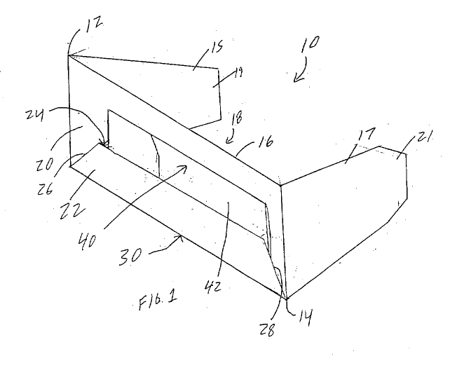

As may be seen in FIG. 1, an embodiment of the invention comprises a card, indicated generally at 10. The card 10 may be constructed from any material suitable for stationary or document applications. Some examples of suitable construction materials include card stock, card board, paper or parchment of any weight or consistency, fabric or any material suitable for use in stationary products.

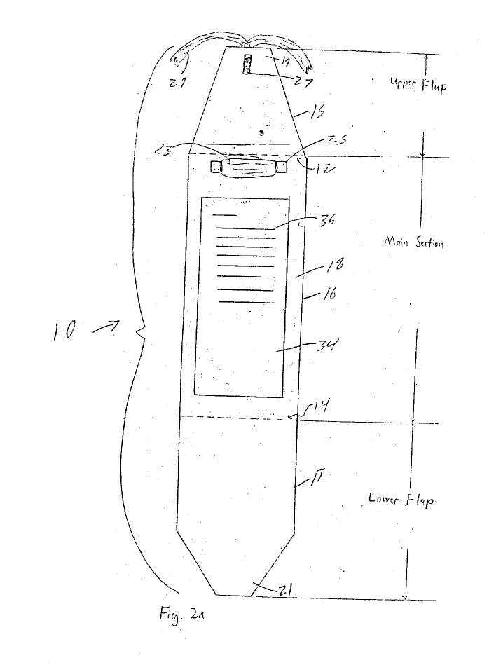

Card 10, is a trisectioned card in which two folds 12 and 14 occur above and below the main section or panel 16. The main panel 16 includes a front surface 18, best shown in FIG. 2a and a rear surface 20.

As is shown in FIG. 2a, at least a portion of the front surface 18 of the main panel 16, includes a message containing portion 34. The message containing portion 34 may be defined by the front surface 18 and/or may include a separate piece of stationary material engaged to the front surface 18. By engaging multiple pieces of material to the front surface 18, multiple pages, of text 36, pictures or other communications may be included in the message containing portion 34.

As is shown in FIGS. 1 and 2a-2b, adjacent to main panel 16 is an upper flap or panel 15 and a lower flap or panel 17. Upper panel 15 may be folded along fold 12 between the open position shown in FIG. 2a and the closed position shown in FIG. 2b. Lower panel 17 may be folded along fold 14 between the open position shown in FIG. 2a and the closed position shown in FIG. 2b. In the closed position the upper and lower panels 15 and 17 substantially overlap the front surface 18 of the main panel 16.

When in the closed position one of the panels 15 or 17 overlaps the other panel. In the embodiment shown in FIG. 2b, the upper panel 15 includes a lip portion 19 which overlappingly engages a lip portion 21 of the lower panel 17. As is shown in the FIGS. 1 and 2a-2b, at least a portion of the panels 15 an 17 are tapered in shape having a substantially frustoconical appearance. By providing panels 15 and 17 with such a shape, at least a portion of the message containing portion 34 is visible even when the panels 15 and 17 are in the closed position. Throughout this application the term frustoconical will be defined as a shape like that of the cross-section of a frustoconical body. A frustoconical body is one in which the tip of a conical solid is removed.

In some embodiments, the upper panel 15 may include a member 23 which may be threaded through openings 25 in the main panel 16 (shown in FIG. 2a) and openings 27 in the upper panel 15. Ends 29 of member 23 may extend from the upper panel 15 to at least partially overlap the lower panel 17 when in the closed position. Member 23 may be any material including lace, ribbon or other fabric. Member 23 aids in identifying which panel 15 or 17 must be unfolded first in order to fully expose the message containing portion 34. In an alternative embodiment of the invention, the ends 29 may be removably engaged to the lower panel 17.

Turning to the rear surface 20 of the main panel 16, attached to the rear surface 20 is a sleeve member 22 which in combination with the rear surface 20 defines a containment slot or sleeve 24.

Sleeve member 22 may be comprised of an elongate piece of stationery material having ends 26 and 28 which are at least partially engaged to the rear surface 20, or may be a portion of the main panel 16 folded back upon the rear surface 20. The ends 26 and 28 of the sleeve member 22 may be engaged to the rear surface 20 by any suitable means including adhesive engagement. Other mechanical means can be used as well to secure the member 22 to the rear surface 20. For example, ribbon, twine or other pliable materials can be used to lace the ends 26 and 28 to the main panel 16 to create the slot 24.

In addition to engaging the ends 26 and 28 to rear surface 20, where sleeve member 22 is a separate member from the main panel 16, at least a portion of bottom edge 30 of the sleeve member 22 is also engaged to the rear surface 20 to form the sleeve 24 between the sleeve member 22 and the rear surface 20.

As is shown in FIG. 1, the sleeve 24 is defined by the sleeve member 22 and the rear surface 20 of the main panel 16. The sleeve 24 is sized to receivingly and removably engage a return envelope, postcard, photo, document or other item of stationary, herein after collectively referred to as return card 40.

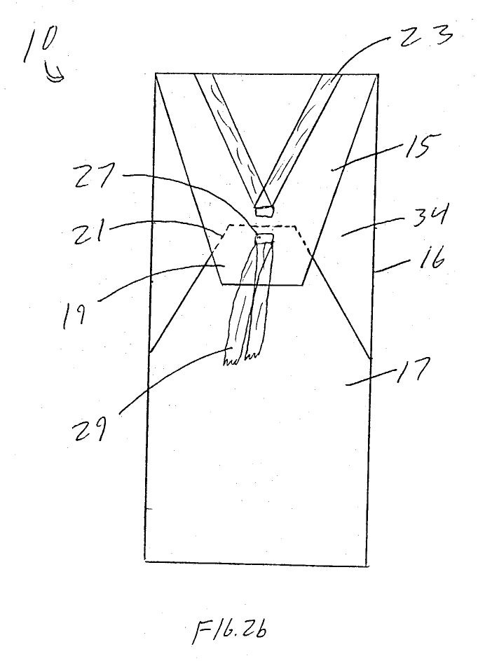

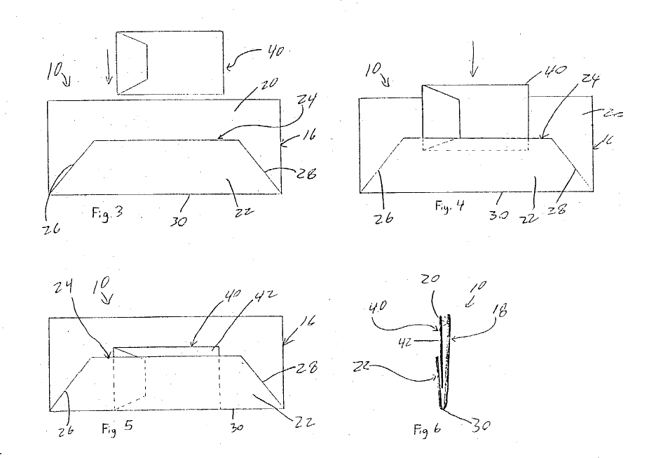

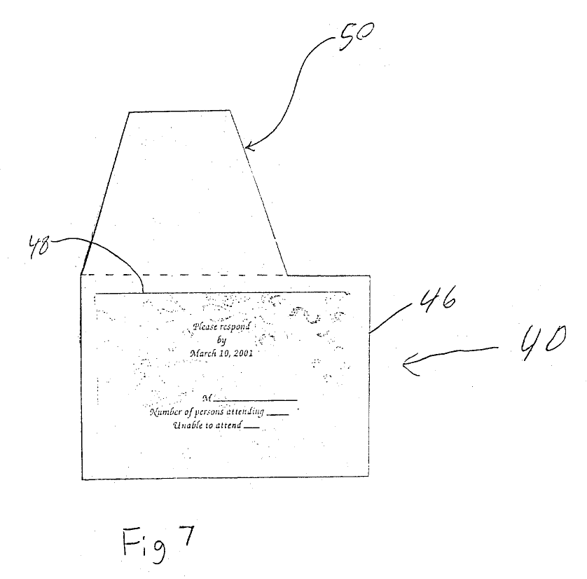

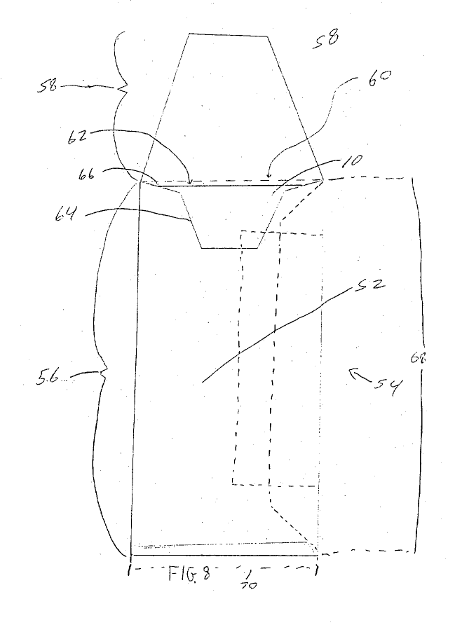

When inserted into the sleeve 24, such as in the manner shown in FIGS. 3-5, a portion 42 of return card 40 remains visibly exposed above sleeve member 22. In some embodiments, the portion 42 left exposed by the sleeve member 22 will be equal to about half of the height of the return card 40, such as is shown in FIG. 6. In some embodiments more than half of the surface of the return card 40 may covered by the sleeve member 22, such as may be seen in FIG. 5. By leaving a portion of the return card 40 exposed, the return card may be easily inserted and/or withdrawn from the sleeve 24. The sleeve 24 provides other functional benefits as well. First, engagement of the return card 40, within sleeve 24 helps to ensure that the return card 40 is not lost or misplaced upon receipt of the trisectioned card 10. Second, the use of the sleeve 24 ensures that the primary message or image of the trisectioned card is not distracted from by secondary items, such as the return card 40.

As indicated above return card 40 may be a variety of different paper product or stationary items. In the embodiment shown in FIG. 7, return card 40 comprises a return envelope 46 in which an RSVP or other type of card or note 48 may be contained. Envelope 46 may by any type of envelope, but in some embodiments includes a unique tapered flap 50 which is similar in shape to the upper panel 15 or lower panel 17 of the trisectioned card 10, such as is shown in FIGS. 2a and 2b.

In another aspect of the invention shown in FIG. 8, a sending envelope 52 is utilized with card 10 and return card 40, the combination of at least these three components comprises a mailing unit 54.

In at least one embodiment of the invention, the sending envelope 52 comprises a body portion 56 and a securement flap 58. Flap 58 is foldable relative to the body 56 along fold 60. The body portion 56 defines an envelope chamber or sleeve 62 into which the card 10 and associated return card 40 may be inserted or removed. In some embodiments of the invention, the body 56 defines a notch 64. Notch 64 allows a portion of the card 10 to be visible and easily graspable once the flap 58 is folded into the open position shown. One of ordinary skill in the art will recognize that in the closed position the flap 58 may be adhesively or otherwise engaged to the body portion 56 to secure the card 10 within the sleeve 62. In at least one embodiment the flap 58 defines a frustoconical shape similar to either the upper panel 15 or lower panel 17 of the card 10 as is shown in FIGS. 2a and 2b.

As is shown in FIG. 8, the body portion 56 of the sending envelope 52 has a height 68 and a width 70. In at least one embodiment, width 70 is less than height 68. In at least one preferred embodiment the width 70 is less than about half of the height 68. The opening 66 of the sleeve 62 is defined by the width 70.

In addition to being directed to the specific combinations of features claimed below, the invention is also directed to embodiments having other combinations of the dependent features claimed below and other combinations of the features described above.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

1. A greeting card comprising:
a main panel, the main panel having a front surface and a rear surface, the front surface having a message containment area; and
a sleeve member, the sleeve member overlapping at least a portion of the rear surface of the main panel, the sleeve member having a bottom edge, a top edge and two side edges, each of the two side edges and the bottom edge being engaged to the rear surface of the main panel, the sleeve member and the rear surface defining a sleeve, the sleeve having an opening defined by the top edge of the sleeve member and the rear surface adjacent thereto, the sleeve constructed and arranged to receive and removably retain at least a portion of at least one stationary item.

2. The greeting card of claim 1 wherein the at least one stationary item is at least one member of the group consisting of, greeting cards, envelopes, RSVP cards, postcards, business reply cards, letters, photographs, documents and any combinations thereof.

3. The greeting card of claim 1 further comprising a first panel and a second panel, the first panel being engaged to the main panel along a first fold line, the second panel being engaged to the main panel along a second fold line, the first panel and the second panel being foldable relative to the main panel such that in an open position the front surface of the main panel is substantially exposed and in the closed position the front surface of the main panel is substantially covered from view.

4. The greeting card of claim 3 wherein at least a portion of at least one of the first panel and the second panel are substantially frustoconical in shape.

5. The greeting card of claim 3 wherein when the first panel and the second panel are in the closed position at least a portion of the first panel overlaps at least a portion of the second panel.

6. The greeting card of claim 3 wherein a portion of the message containment area is visible when the first panel and the second panel are in the closed position.

7. A mailing comprising:
A greeting card, the greeting card having:
a main panel, a first panel and a second panel, the main panel having a front surface and a rear surface, the front surface having a message containment area, the first panel being engaged to the main panel along a first fold line, the second panel being engaged to the main panel along a second fold line, the first panel and the second panel being foldable relative to the main panel such that in an open position the front surface of the main panel is substantially exposed and in the closed position the front surface of the main panel is substantially covered from view;
a sleeve member, the sleeve member overlapping at least a portion of the rear surface of the main panel, the sleeve member having a bottom edge, a top edge and two side edges, each of the two side edges and the bottom edge being engaged to the rear surface of the main panel, the sleeve member and the rear surface defining a sleeve, the sleeve having an opening defined by the top edge of the sleeve member and the rear surface adjacent thereto;
at least one stationary item, the at least one stationary item constructed and arranged to be received by and removably retained by the sleeve; and
a sending envelope, the sending envelope defining a card sleeve, the card sleeve constructed and arranged to receive and removably retain the greeting card therein.

8. The mailing of claim 7 wherein the sending envelope is defined by a height and a width, the greeting card being insertable into the card sleeve along an opening defined by the width of the sending envelope, the width of the sending envelope being less than the height of the sending envelope.

9. The mailing of claim 8 wherein the sending envelope further comprises a flap, the at least one flap having an open position and a closed position, in the open position the greeting card being removable from the card sleeve, in the closed position the greeting card being completely contained within the card sleeve.
